(19) United States
(12) Patent Application Publication
(10) Pub. No.: US 2025/0128765 A1
(43) Pub. Date: Apr. 24, 2025

(54) VEHICLE BODY FRONT STRUCTURE

(71) Applicant: HONDA MOTOR CO., LTD., Tokyo (JP)

(72) Inventor: Keita Ishihara, Tokyo (JP)

(21) Appl. No.: 18/916,793

(22) Filed: Oct. 16, 2024

(30) Foreign Application Priority Data
Oct. 19, 2023 (JP) 2023-180520

(51) Int. Cl. B62D 21/15; B62D 21/02

(52) U.S. Cl. CPC B62D 21/152; B62D 21/02

(57) ABSTRACT

This vehicle body front structure includes front side frames extending from sides of a front part of a vehicle substantially in a forward/rearward direction, and a load transfer block that is a casting part configured to connect rear parts of the front side frames to separate frame members, the load transfer block having a frame insertion part that opens forward, and into which the rear region of the front side frames is inserted from the opening, and a load support wall standing from an edge portion of the opening in a direction substantially perpendicular to the forward/rearward direction, a bracket protruding in a direction crossing the forward/rearward direction and abutting a front surface of the load support wall being provided at a position in front of an area of the front side frames inserted into the frame insertion part, the front side frames being fastened and fixed to a circumferential wall of the frame insertion part in the upward/downward direction by a first fastening member and fastened and fixed to the circumferential wall from a vehicle width direction by a second fastening member in a state in which the rear region is inserted into the frame insertion part of the load transfer block, and the bracket being fastened and fixed to the load support wall of the load transfer block in the forward/rearward direction by a third fastening member.

### CROSS-REFERENCE TO RELATED APPLICATION

The present application claims priority based on Japanese Patent Application No. 2023-180520, filed Oct. 19, 2023, the content of which is incorporated herein by reference.

### BACKGROUND OF THE INVENTION

### Field of the Invention

The present invention relates to a vehicle body front structure.

### Description of Related Art

In recent years, various efforts to provide access to sustainable transport systems have been gaining momentum. To achieve this, further improving traffic safety and convenience through research for improving vehicle body rigidity has been focused upon.

As a front structure of a vehicle body, there is known a structure in which a pair of front side frames are disposed on left and right sides of a vehicle front part and rear parts of the front side frames are connected to separate frame members via a load transfer block (for example, see Japanese Unexamined Patent Application, First Publication No. 2002-166853).

The vehicle body front structure disclosed in Japanese Unexamined Patent Application, First Publication No. 2002-166853 is constituted by an upper block in which a load transfer block functions as a strut housing, and a lower block coupled to a lower end of the upper block, and fitting holes extending in a forward/rearward direction are formed between the upper block and the lower block. The upper block and the lower block are each integrally formed by casting. Rear regions of the front side frames can be fitted into the fitting holes formed by the upper block and the lower block.

In the case of the vehicle body front structure, a plate-shaped part abutting side surfaces of rear regions of the front side frames is provided on a portion that constitutes a part of the fitting hole on the side of the upper block, and the plate-shaped part is fixed to the side surfaces of the front side frames through welding. The lower block is connected to the front side frames after the rear regions of the front side frames are fixed to the upper block through welding. Here, the rear regions of the front side frames are disposed inside the fitting holes formed between the upper block and the lower block in a fitted state.

In the vehicle body front structure, since the load transfer block is constituted by the upper block and the lower block that are casting parts, the number of parts of the components of the load transfer block can be reduced. In addition, since the side surfaces of the rear regions of the front side frames are welded to a plate-shaped part of the upper block, it is possible to secure a large area for the welded portion and increase support rigidity of the rear regions of the front side frames. For this reason, when an impact load is input from in front of the vehicle, the front side frames can be smoothly crushed.

### SUMMARY OF THE INVENTION

However, in the vehicle body front structure disclosed in Japanese Unexamined Patent Application, First Publication No. 2002-166853, the load transfer block has to be constituted by the upper block and the lower block, and the plate-shaped part configured to fix the front side frames to the upper block through welding must be formed. For this reason, not only does the structure of the load transfer block become more complex, but also the work required to fix the front side frames becomes more cumbersome. In addition, when the load transfer block is constituted by the casting parts, depending on the shape of the abutting part with respect to the front side frames and the properties of the material used for the casting parts, it may be difficult to achieve strong welding.

For this reason, the rear regions of the front side frames being fixed to the load transfer block by a fastening member while simplifying the structure of the load transfer block is currently being considered.

However, when a plurality of discrete points of the rear regions of the front side frames are fixed using fastening members, stress is more likely to act on only a part of the periphery of the front side frames when an impact load is input from the front of the vehicle. Then, when stress acts unevenly on a part of the periphery of the front side frames, that stress causes inclination or bending of the front side frames, impeding the smooth crushing (energy absorption) of the front side frames.

An aspect of the present invention is directed to providing a vehicle body front structure capable of obtaining smooth crushing of front side frames when an impact load is input from in front even when rear regions of the front side frames are fixed to a load transfer block using a fastening member. Then, in turn, the present invention is directed to contributing to development of a sustainable transport system.

In order to accomplish the above-mentioned purposes, a vehicle body front structure according to an aspect of the present invention employs the following configurations.

(1) An aspect of the present invention is a vehicle body front structure including: front side frames (for example, front side frames (10) of an embodiment) extending from sides of a front part of a vehicle substantially in a forward/rearward direction; and a load transfer block (for example, a load transfer block (11) of the embodiment) that is a casting part configured to connect rear parts of the front side frames to separate frame members, the load transfer block having: a frame insertion part (for example, a frame insertion part (30) of the embodiment) that opens forward, and into which the rear region of the front side frames is inserted from the opening; and a load support wall (for example, a load support wall (32) of the embodiment) standing from an edge portion of the opening in a direction substantially perpendicular to the forward/rearward direction, a bracket (for example, a bracket (33) of the embodiment) protruding in a direction crossing the forward/rearward direction and abutting a front surface of the load support wall being provided at a position in front of an area of the front side frames inserted into the frame insertion part, the front side frames being fastened and fixed to a circumferential wall of the frame insertion part in the upward/downward direction by a first fastening member (for example, a bolt (35A) of the embodiment) and fastened and fixed to the circumferential wall from a vehicle width direction by a second fastening member (for example, a bolt (35B) of the embodiment) in a state in which the rear region is inserted into the frame insertion part of the load transfer block, and the bracket being fastened and fixed to the load support wall of the load transfer block in the forward/rearward direction by a third fastening member (for example, a bolt (34) of the embodiment).

According to the aspect of the above-mentioned (1), when an impact load is input from the front of the front side frames, the load is supported by the circumferential wall of the frame insertion part of the load transfer block through the first fastening member and the second fastening member. Here, the input load is supported by the first fastening member and the second fastening member in a distributed manner on the wall facing the upward/downward direction of the frame insertion part and on the wall facing the vehicle width direction. In addition, the impact load input to the front side frames is also supported by the load support wall of the load transfer block through the third fastening member configured to fasten and fix the bracket to the load support wall of the load transfer block. Accordingly, the input load is supported in a distributed manner by the load support wall facing the forward/rearward direction of the load transfer block. Accordingly, when the impact load is input from the front, it is less likely to apply stress on a part of the periphery of the front side frames, and thus, inclination or bending of the front side frames is less likely to occur.

(2) In the aspect of the above-mentioned (1), the load support wall of the load transfer block may stand upward from the edge portion of the opening, and the bracket may stand upward from upper surfaces of the front side frames.

According to the aspect of the above-mentioned (2), when the bracket is fastened and fixed to the load support wall of the load transfer block by the third fastening member, the rear region of the front side frames is fixed to the load transfer block by being suspended from above via the bracket. For this reason, the rear region of the front side frames is stably supported by the load transfer block. In addition, when the impact load is input from the front, it is less likely to cause inclination or bending to occur on the rear region of the front side frames.

(3) In the aspect of the above-mentioned (1), the load transfer block may further have an enclosure wall (for example, an enclosure wall (50) of the embodiment) protruding forward from a periphery of the opening of the frame insertion part and surrounding outer circumferential surfaces of the front side frames, and a crush accommodating space (for example, a crush accommodating space (55) of the embodiment) configured to accommodate a crushed portion when the front side frames are crushed in the forward/rearward direction may be provided between the enclosure wall and the front side frames.

According to the aspect of the above-mentioned (3), when the front side frames are crushed and deformed from the front part side toward the rear end side by the input of the impact load from the front, the crushed portion is accommodated in a crush accommodating space between the enclosure wall and the front side frames according to advance of the crush. For this reason, when the impact load is input, it is less likely to cause bending and deformation to occur on the rear region of the front side frames. Accordingly, when the configuration is employed, the front side frames can be more smoothly crushed and deformed.

In addition, a part of the crushed portion accommodated in the crush accommodating space wraps around to the front surface side of the load support wall. As a result, retraction displacement of the rear region of the front side frames is also restricted by contact between the crushed portion and the load support wall. Accordingly, when the impact load is input, the front side frames can be more smoothly crushed and deformed.

(4) In the aspect of the above-mentioned (1), at least one of the first fastening member and the second fastening member may be provided in plural, directed in the forward/rearward direction and disposed in a zigzag pattern in a direction crossing the forward/rearward direction.

According to the aspect of the above-mentioned (4), when the impact load is input from the front, if the crushing of the front side frames advances to the rear region, deformation also progresses from the front to the rear in the peripheral portion of each fastening member. Here, in this configuration, since the plurality of fastening members are disposed in a zigzag pattern, deformation points in the rear region of the front side frames are distributed to multiple positions in the vehicle width direction or the upward/downward directions. Accordingly, when the configuration is employed, it is possible to effectively curb collapse or breakage of the front side frames in the later stage of the impact load input.

(5) In the aspect of the above-mentioned (1), a reinforcement wall (for example, a reinforcement wall (37) of the embodiment) extending across an internal space of the front side frames may be connected to left and right sidewalls of the front side frames, and the reinforcement wall may extend across at least a fastening part of the second fastening member in the forward/rearward direction.

According to the aspect of the above-mentioned (5), when the impact load is input from the front, the load transmitted to the left and right sidewalls of the front side frames can be roughly equalized by the function of the reinforcement wall. Accordingly, when the configuration is employed, it is possible to effectively suppress the collapse or breakage in the leftward/rightward direction of the front side frames in the later stage of the impact load input.

(6) In the aspect of the above-mentioned (1), the first fastening member and the second fastening member may fasten and fix the front side frames and the frame insertion part at positions offset to each other in the forward/rearward direction.

According to the aspect of the above-mentioned (6), when the impact load is input from the front, if the crushing of the front side frames advances to the rear region, deformation also progresses from the front to the rear in the peripheral portion of each fastening member. Here, in this configuration, since the first fastening member and the second fastening member are disposed to be offset to each other in the forward/rearward direction, deformation of the periphery of the first fastening member and deformation of the periphery of the second fastening member tend to occur alternately. Accordingly, when the configuration is employed, it is possible to effectively suppress the collapse or breakage of the front side frames in the later stage of the impact load input.

According to the aspect of the present invention, the input impact load can be supported by the first fastening member and the second fastening member in a distributed manner in a direction crossing the circumferential wall of the frame insertion part of the load transfer block, and further, can be supported on the load support wall of the load transfer block by the third fastening member in the forward/rearward direction. For this reason, when the impact load is input from the front, it is less likely to apply biased stress to a part of the periphery of the front side frames, and it is less likely cause the inclination or bending to occur on the front side frames. Accordingly, when the vehicle body front structure according to the present invention is employed, while the rear region of the front side frames is fixed to the load transfer block by the fastening member, the front side frames can be smoothly crushed when the impact load is input from the front.

### BRIEF DESCRIPTION OF THE DRAWINGS

FIG. 1 is a perspective view of a front part of a vehicle of an embodiment.

FIG. 2 is a side view of the front part of the vehicle of the embodiment.

FIG. 3 is a perspective view when a load transfer block of the embodiment is seen from above a rear part.

FIG. 4 is a cross-sectional view of the front part of the vehicle corresponding to a cross section along line IV-IV in FIG. 3.

FIG. 5 is a perspective view showing a fixing part of front side frames and a load transfer block of the embodiment.

FIG. 6 is a partially enlarged cross-sectional view of FIG. 4.

FIG. 7 is a front view of the fixing part of the front side frames and the load transfer block when seen by cutting the front side frames of the embodiment along line VII-VII of FIG. 4.

FIG. 8 is a plan view of the front side frames of the embodiment along line VIII-VIII of FIG. 7.

### DESCRIPTION OF EMBODIMENTS

Hereinafter, an embodiment of the present invention will be described with reference to the accompanying drawings. Further, in appropriate places of the drawings, an arrow FR indicates a forward direction of a vehicle, an arrow UP indicates an upward direction of the vehicle, and an arrow LH indicates a leftward direction of the vehicle (a leftward side when the vehicle is directed forward).

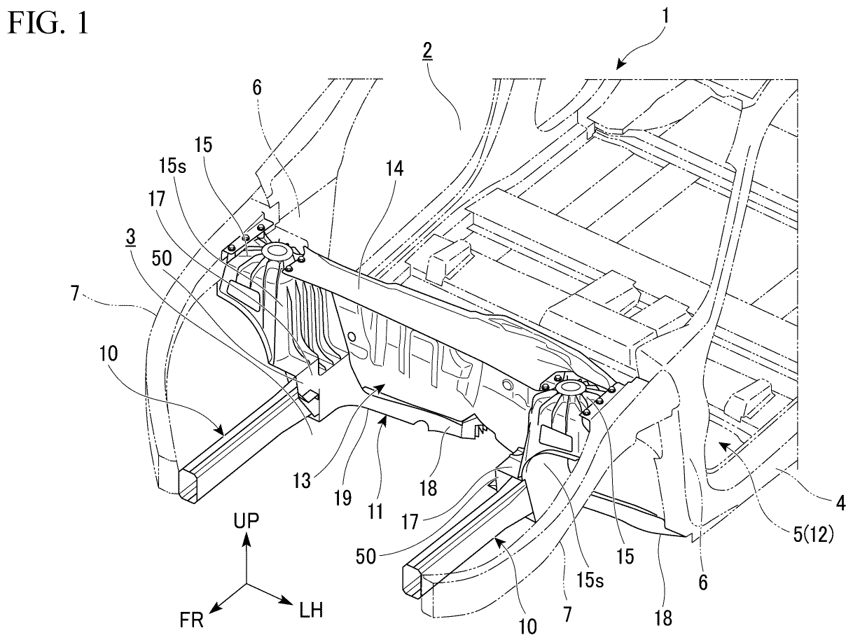

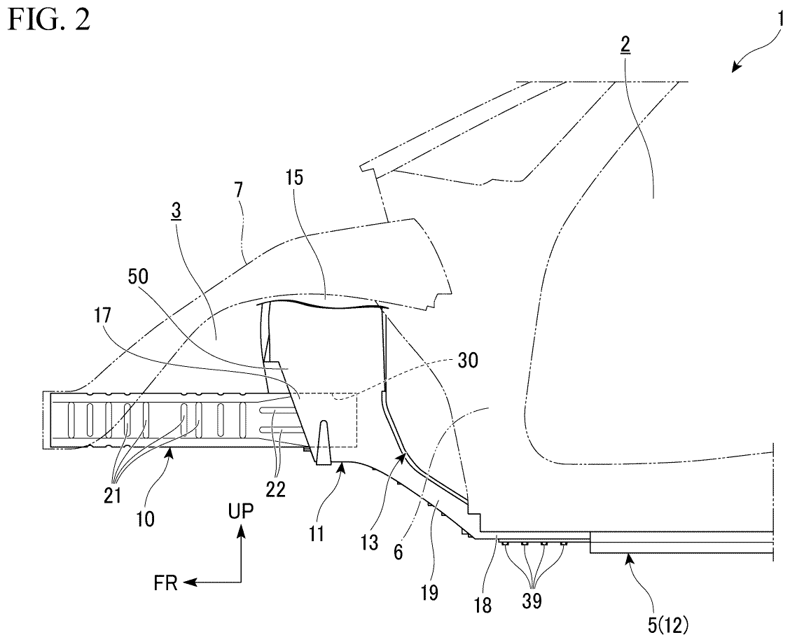

FIG. 1 is a perspective view of a front part of a vehicle 1 of the embodiment, and FIG. 2 is a side view of the front part of the vehicle 1 when seen from a left side.

Reference sign 2 in FIG. 1 and FIG. 2 designates a passenger compartment in which an occupant rides, and reference sign 3 designates a front compartment in front of the passenger compartment 2 and in which a driving motor, an engine, or the like, is accommodated. Front side frames 10 extending substantially in a vehicle body forward/rearward direction are disposed on both sides of the front compartment 3 in a vehicle width direction. Rear end portions of the left and right front side frames 10 are connected to a frame member of a front part of the passenger compartment 2 via a load transfer block 11, which will be described below in detail.

Side sills 4 extending substantially in the vehicle body forward/rearward direction are disposed on left and right side portions of a lower side of the passenger compartment 2. A floor panel 5 disposed below the passenger compartment 2 is installed across the left and right side sills 4. The floor panel 5 is reinforced by a plurality of reinforcement frames (not shown) extending in a forward/rearward direction and a widthwise direction of the vehicle body.

In the embodiment, the floor panel 5 and these reinforcement frames are collectively referred to as a floor member 12. Further, the left and right front side frames 10 extend forward from positions above the floor member 12.

A space between the front part of the passenger compartment 2 and the front compartment 3 is partitioned by a dashboard lower panel 13. The dashboard lower panel 13 has a lower end connected to a front edge portion of the floor member 12, and stands up to be inclined forward and upward from the front part of the floor member 12. An upper portion of the dashboard lower panel 13 is connected to a cowl top panel 14 or the other frame members.

Front pillars 6 that constitute a front edge of a door opening on the front side are connected to front end portions of the left and right side sills 4. Upper members 7 extending substantially in the vehicle body forward/rearward direction are connected to front surface sides of the upper portions of the front pillars 6 at outer positions of the front compartment 3 in the vehicle width direction. The upper members 7 are curved from the left and right front pillars 6 toward below the front part of the vehicle body, and front end portions thereof extend to positions outside the front end portions of the front side frames 10. The front end portions of the upper members 7 are connected to the front end portions of the front side frames 10 corresponding to left and right sides via a connecting member (not shown).

Damper housing parts 15 of left and right upper portions of the load transfer block 11, which will be described below in detail, are connected to base parts (rear regions) of the left and right upper members 7. The damper housing parts 15 support upper portions of dampers of front suspensions (not shown).

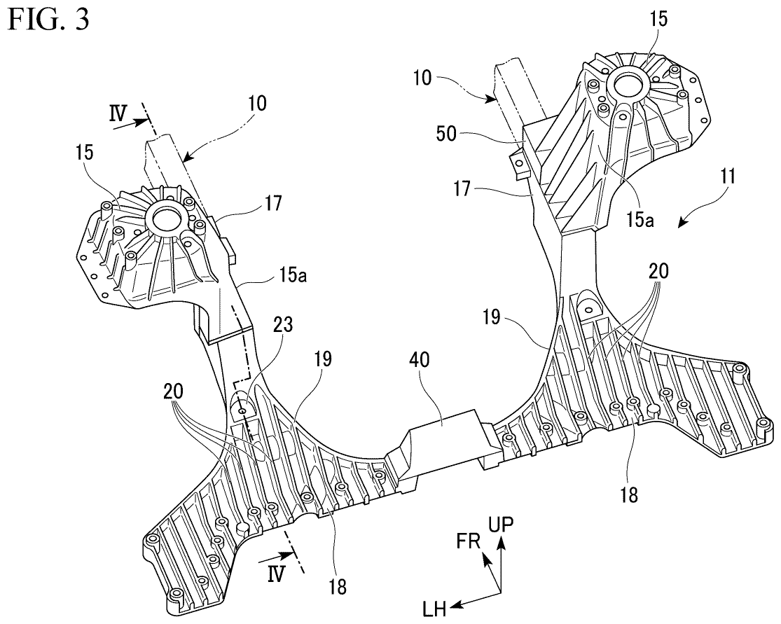

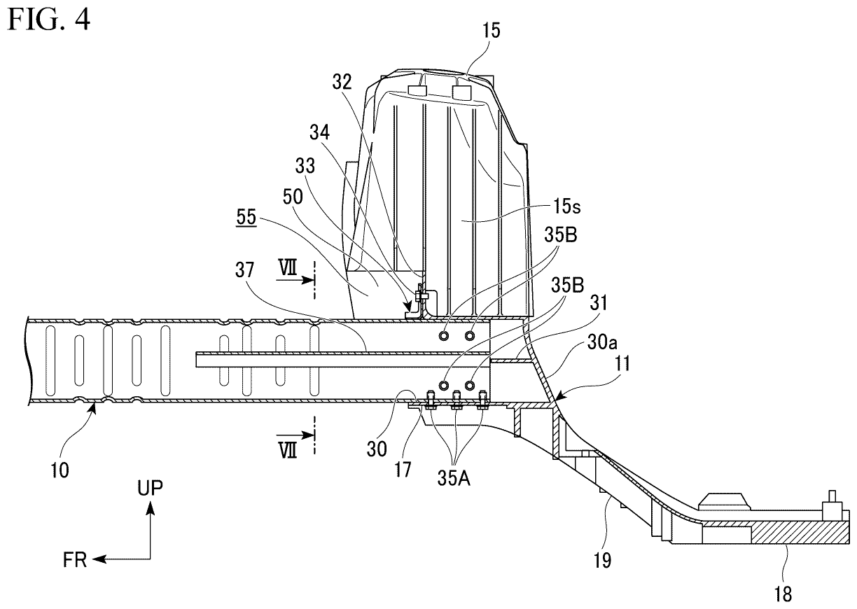

FIG. 3 is a perspective view showing the load transfer block 11 when seen from above the rear part. In addition, FIG. 4 is a cross-sectional view of the front part of the vehicle corresponding to the cross section along line IV-IV in FIG. 3.

The left and right front side frames 10 fixed to the load transfer block 11 are formed in a square tubular (rectangular tubular) frame shape as shown in FIG. 1 and FIG. 4. The rear end portions of the front side frames 10 are inserted into a frame fixing part 17 of the load transfer block 11 described below, and in this state, are fixed to the frame fixing part 17 by a plurality of bolts 35A and 35B (fastening members). The front side frames 10 are formed of for example, aluminum, ferrous metals, or the like.

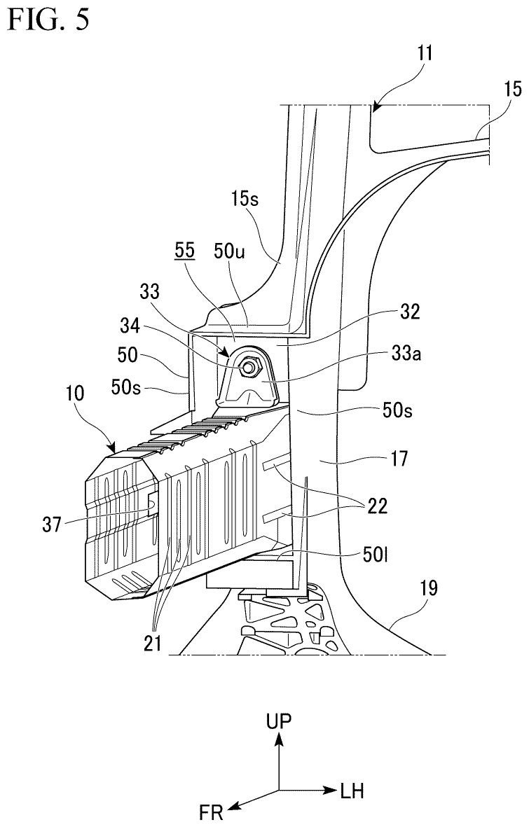

FIG. 5 is a perspective view showing a fixing part of the front side frames 10 and the load transfer block 11. The front side frames 10 are frame members that support driving system parts or suspension members arranged in the front compartment 3, but when an impact load is input from the front of the vehicle, they absorb the energy of the impact load by being crushed in the forward/rearward direction. As shown in FIG. 2 and FIG. 5, a plurality of beads 21 extending in the upward/downward direction are provided on left and right sidewalls of the front side frames 10. The plurality of beads 21 are spaced apart and arranged in the forward/rearward directions on the sidewalls of the front side frames 10. The plurality of beads 21 promotes bellows-like crush deformation of the front side frames 10 when an impact load is input.

The beads 21 extending in the upward/downward direction are provided only from intermediate regions to front regions of the sidewalls of the front side frames 10 in the forward/rearward direction. A plurality of beads 22 extending in the forward/rearward direction are provided on rear regions of the sidewalls of the front side frames 10. The beads 22 extending in the forward/rearward direction of the front side frames 10 restrict deformation of the rear region at the beginning of the crush when the impact load is input.

As shown in FIG. 3, the load transfer block 11 is formed laterally symmetrically. The load transfer block 11 is provided with the damper housing parts 15, the frame fixing part 17, a connecting wall 19, and a floor fixing part 18 in each of the left and right regions. The load transfer block 11 containing these elements is integrally cast from, for example, aluminum. That is, the load transfer block 11 is an integral casting part that has the above components.

As mentioned above, the damper housing parts 15 are portions that support the upper portion of the damper of the front suspension, and as shown in FIG. 1, are disposed above the front side frames 10 and at positions outside the front side frames 10 in the vehicle width direction. The damper housing parts 15 are formed in a downward bowl shape (a downward bottomed cylindrical shape), and the damper is disposed on the lower side (inside) of the bowl-shaped part. The damper housing parts 15 support the upper portion of the damper of the front suspension at its apex portion.

The damper housing parts 15 are connected to the base parts of the upper members 7 corresponding on the left and right sides as described above through bolt fastening or the like. In addition, the cowl top panel 14 is provided across the left and right damper housing parts 15 connected to the upper members 7. The left and right end portions of the cowl top panel 14 are connected to the damper housing parts 15 corresponding on the left and right sides through bolt fastening or the like.

The frame fixing part 17 is connected to lower sides of sidewalls 15s on the inner side in the vehicle width direction of the damper housing parts 15. The frame fixing part 17 is a part that fixes the rear parts of the front side frames 10, and is formed in a roughly rectangular block shape extending in the vehicle body forward/rearward direction. As shown in FIG. 4, frame insertion parts 30 having a rectangular shape when seen in a front view, into which the rear regions of the front side frames 10 are inserted, are provided in the block portion of the frame fixing part 17. The frame insertion parts 30 are open toward the front of the vehicle, and load receiving ribs 31 protrude from a bottom portion opposite to the opening side. The ribs 31 are load support walls that protrude from bottom walls 30a of the frame insertion parts 30 toward the front of the vehicle, and the two rib pieces intersect to form an X shape when seen in a front view. Front end surfaces of the ribs 31 are contoured to be flat all over. The front end surfaces of the ribs 31 face rear end surfaces of the front side frames 10 with a micro gap sandwiched therebetween when the front side frames 10 are inserted into the frame insertion parts 30.

When the rear parts of the front side frames 10 try to move backward upon input of the impact load from the front, the rear end surfaces of the front side frames 10 comes into contact with the front surfaces of the ribs 31. The front side frames 10 thereby prevent excessive retraction displacement.

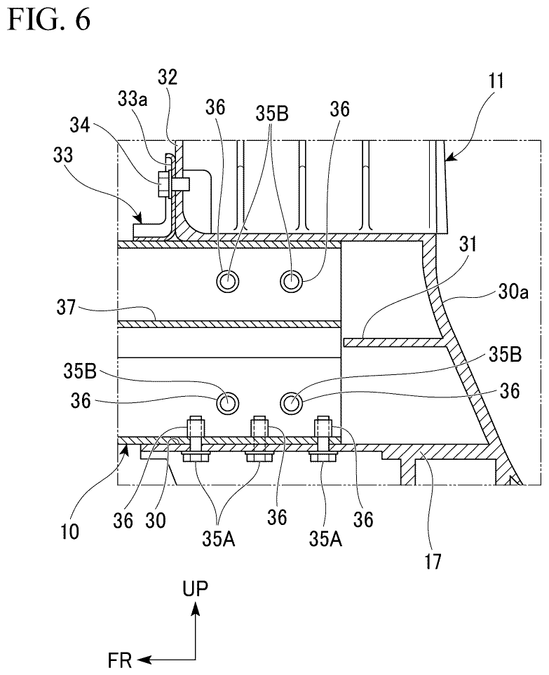

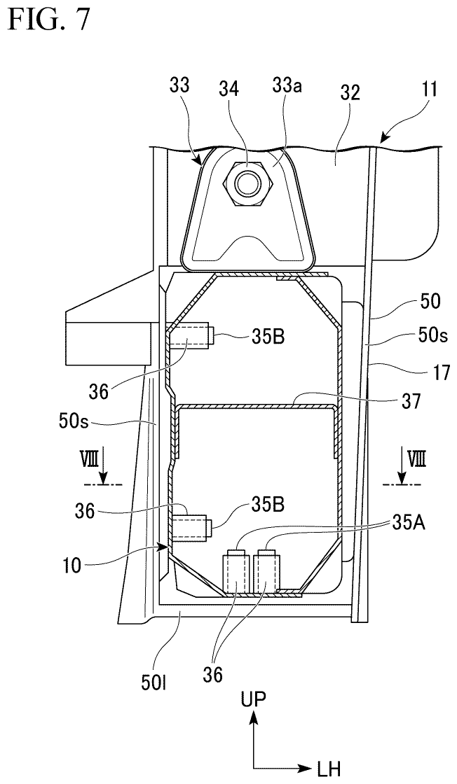

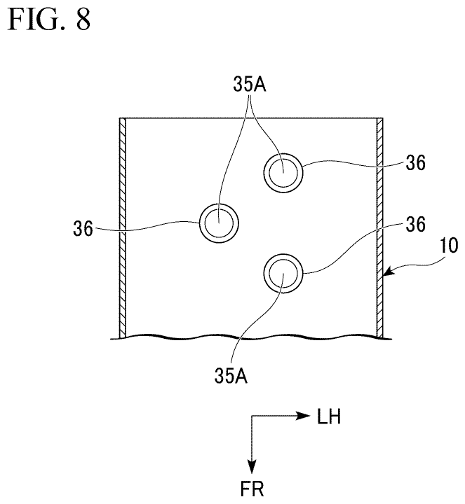

FIG. 6 is a partially enlarged cross-sectional view of FIG. 4. FIG. 7 is a front view of a fixing part of the front side frames 10 and the load transfer block 11 when the front side frames 10 are cut along line VII-VII of FIG. 4. In addition, FIG. 8 is a plan view when the front side frames 10 are cut along line VIII-VII of FIG. 7.

A load support wall 32 continuous with upper opening edges of the frame insertion parts 30 are provided on a front surface side of a block portion of the frame fixing part 17. The load support wall 32 is a flat wall perpendicular to the vehicle body forward/rearward direction and extends vertically upward from the upper opening edge of the frame insertion parts 30.

In addition, as shown in FIG. 5 and FIG. 7, an enclosure wall 50 protruding forward from the periphery of the region joined to the opening of the frame insertion parts 30 and the front surface of the load support wall 32 is provided on the front surface of the block portion of the frame fixing part 17. The enclosure wall 50 is a rectangular tubular wall when seen in a front view, and surrounds the outside of the front side frames 10 protruding forward from the openings of the frame insertion parts 30. The enclosure wall 50 has an upper wall 50u and a lower wall 501, and left and right sidewalls 50s, and forms at least a gap between the upper wall 50u and the left and right sidewalls 50s and the outer circumferential surfaces of the front side frames 10. This gap constitutes a crush accommodating space 55 that receives the crushed portion when the front side frames 10 receive an impact load from the front and are crushed in the forward/rearward direction.

A bracket 33, which is roughly L-shaped when seen in a side view, is fixed to the upper surfaces of the front side frames 10 near the rear part by welding or the like. The bracket 33 is fixed at a position in front of the portion of the upper surface of the front side frames 10 that is inserted into the frame insertion parts 30. A standing piece 33a of the bracket 33 is abutted against the front surface of the load support wall 32 of the frame fixing part 17 and is fixed in this state to the load support wall 32 by a bolt 34 (third fastening member). The bolt 34 has a shaft portion that extends in the vehicle body forward/rearward direction to be tightened into the load support wall 32, thereby regulating the displacement of the front side frames 10 in the vehicle body forward/rearward direction. The bracket 33 is fastened and fixed to the load support wall 32 of the load transfer block 11 by the bolt 34 (third fastening member) in the forward/rearward direction.

In addition, the rear regions of the front side frames 10 inserted (fitted) into the frame insertion parts 30 of the frame fixing part 17 are fastened and fixed to the lower walls and one of the sidewalls of the frame insertion parts 30 by the plurality of bolts 35A and 35B (first fastening member and second fastening member).

The bolt 35A (first fastening member) vertically pass through the lower wall of the frame insertion part 30 and is fastened to a tubular nut 36 protruding from the upper surface of the lower wall and formed of a ferrous metal. Similarly, the bolt 35B (second fastening member) passes through the sidewall of one of the frame insertion parts 30 and is fastened to the tubular nut 36 protruding from the inner surface of the sidewall and formed of a ferrous metal. The front side frames 10 are fastened and fixed to the circumferential wall (lower wall) of the frame insertion parts 30 by the bolt 35A in the upward/downward direction and fastened and fixed to the circumferential wall (one sidewall) of the frame insertion part 30 by the bolt 35B in the vehicle width direction.

As shown in FIG. 6 to FIG. 8, three bolts 35A are provided for fastening the front side frames 10 to the lower walls of the frame insertion parts 30. The plurality of bolts 35A are disposed in a zigzag pattern across the vehicle width in the forward/rearward direction of the front side frames 10. That is, the plurality of bolts 35A are disposed alternately on the left and right sides, sandwiching the center of the widthwise direction of the lower wall of the front side frames 10.

In addition, the bolts 35B that fasten the front side frames 10 to the sidewalls of the frame insertion parts 30 are disposed at two places of upper sides and two places lower sides of the sidewalls of the front side frames 10. The corresponding bolts 35B above and below are disposed at the same position in the forward/rearward direction. In addition, as shown in FIG. 6, the two rear bolts 35B are located at a substantially intermediate position between the rearmost and the central bolts 35A of the three bolts 35A for fixing to the lower wall in the forward/rearward direction. Similarly, the two front bolts 35B are located at a substantially intermediate position between the center and the foremost bolts 35A of the three bolts 35A for fixing to the lower wall in the forward/rearward direction. Accordingly, the bolt 35A (first fastening member) for fixing to the lower wall and the bolt 35B (second fastening member) for fixing to the sidewall fasten and fix the front side frames 10 and the frame insertion parts 30 at positions offset to each other in the forward/rearward direction.

As shown in FIG. 6 and FIG. 7, reinforcement walls 37 (bulkhead) that extend in the horizontal direction and connect left and right sidewalls of the front side frames 10 are provided in the rear regions of the front side frames 10. The reinforcement walls 37 extend from the rear end portions of the front side frames 10 to a position in front of the connection part of the front side frames 10 and the frame fixing part 17 by the bracket 33 and the bolt 34. The reinforcement walls 37 extend across the connection part of the front side frames 10 and the frame fixing part 17 by the bolts 35A and 35B and the connection part by the bracket 33 and the bolt 34 in the forward/rearward direction.

However, the reinforcement wall 37 needs to extend at least so as to cross the fastening part of the bolt 35B for fixing to the sidewall in the forward/rearward direction.

In addition, as shown in FIG. 2 and FIG. 3, the floor fixing part 18 of the load transfer block 11 extends along the front edge portion of the floor member 12 in the vehicle width direction. The floor fixing part 18 is formed in a long plate shape with a sufficient vertical thickness. The floor fixing part 18 overlaps the front edge portion of the floor member 12 and is fixed to the floor member 12 by a plurality of bolts.

A left region and a right region, which are laterally symmetrical to each other, of the load transfer block 11 are connected to each other in the floor fixing part 18 of the left region and the floor fixing part 18 of the right region. Specifically, as shown in FIG. 3, the floor fixing part 18 of the left region and the floor fixing part 18 of the right region are connected to each other by a connection block portion 40 at a substantially central position in the vehicle width direction.

The connecting wall 19 of the load transfer block 11 extends substantially along the front surface of the dashboard lower panel 13 disposed on the front part of the passenger compartment 2, and connects the frame fixing part 17 and the floor fixing part 18 there below. The connecting wall 19 is formed in a plate shape having the same sufficient thickness as the floor fixing part 18 described above. The connecting wall 19 is smoothly connected to the floor fixing part 18 below to form a continuous plate shape.

The connecting wall 19 has an upper end portion connected to the rear lower end of the block portion of the frame fixing part 17. The connecting wall 19 widens downward in a wide-ended shape in the vehicle width direction, starting from the connecting portion with the frame fixing part 17 as the apex. That is, the connecting wall 19 is formed in an approximately isosceles triangular shape when seen in a front view. The lower end region of the connecting wall 19, which expands into a wide-ended shape, is continuous with (connected to) the floor fixing part 18.

A plurality of upper reinforcement ribs 20 standing upward in the forward/rearward direction (inclined forward/rearward direction) protrude toward the upper surface of the connecting wall 19. The plurality of upper reinforcement ribs 20 are formed on the upper surface side of the connecting wall 19 so as to be spaced apart in the vehicle width direction and parallel to each other.

In addition, as shown in FIG. 3, the upper surface of the upper region of the connecting wall 19, which is narrower in the vehicle width direction, is formed with a panel fixing part 23, which is partially recessed in a stepped shape and has a flat upper surface. The dashboard lower panel 13 is fastened and fixed to the panel fixing part 23.

### Effects of Embodiment

As described above, in the vehicle body front structure of the embodiment, the front side frames 10 are inserted into the frame insertion parts 30 of the load transfer block 11, and in this state, the front side frames 10 and the circumferential wall of the frame insertion parts 30 are fastened and fixed by the bolt 35A (first fastening member) in the upward/downward direction and simultaneously fastened by the bolt 35B (second fastening member) in the vehicle width direction. Then, the bracket 33 protruding from the front side frames 10 is fastened and fixed to the load support wall 32 of the load transfer block 11 in the forward/rearward directions by the bolt 34 (third fastening member). For this reason, when the impact load is input from the front, the input load can be supported in a distributed manner in mutually intersecting directions on the circumferential walls of the frame insertion parts 30 by the bolts 35A and 35B, and further supported in the forward/rearward directions on the load support wall 32 of the load transfer block 11 by the bolt 34. As a result, when the impact load is input from the front, it becomes difficult for stress to act on only a part of the periphery of the front side frames 10, and inclination or bending of the front side frames 10 becomes difficult to occur.

Accordingly, when the vehicle body front structure of the embodiment is employed, while the rear regions of the front side frames 10 are fixed to the load transfer block 11 by the fastening members (the bolts 35A and 35B, 34), the front side frames 10 can be smoothly crushed when an impact load is input from the front.

In particular, in the vehicle body front structure of the embodiment, a structure in which the bolt 35A (first fastening member) and the bolt 35B (second fastening member) pass through the circumferential wall of the frame insertion parts 30 and are fastened and fixed from the outside of the circumferential wall of the frame insertion parts 30. For this reason, the fastening work of the bolts 35A and 35B can be easily performed.

In addition, in the vehicle body front structure of the embodiment, a structure in which the bracket 33 protrudes from the front side frames 10, the bracket 33 overlaps the front surface of the load support wall 32 of the load transfer block 11, and the bracket 33 are fastened and fixed from the front surface side of the load transfer block 11 by the bolt 34. For this reason, the fastening work of the bolt 34 can be easily performed.

While it is also possible to fasten and fix the bottom portion of the frame insertion parts 30 to the rear end portion of the front side frames 10 using a bolt (fastening member), in this case, if it is tried to ensure the thickness (protrusion height) of the load receiving portion such as the ribs 31, the axial length of the bolt becomes longer, making the fastening work more difficult. On the other hand, when the configuration is employed, not only the axial length of the bolt 34 can be shortened, but also the fastening work of the bolt 34 can be easily performed from the front surface side.

In addition, in the vehicle body front structure of the embodiment, the load support wall 32 of the load transfer block 11 stands upward from the edge portions of the openings of the frame insertion parts 30, and the bracket 33 protrudes upward from the upper surfaces of the front side frames 10. For this reason, when the bracket 33 is fastened and fixed to the load support wall 32 by the bolt 34 (third fastening member), the rear regions of the front side frames 10 are fixed to the load transfer block 11 in a manner that it is suspended from above via the bracket 33. As a result, the rear regions of the front side frames 10 are stably supported by the load transfer block 11. In addition, when the impact load is input from the front, the rear regions of the front side frames 10 are less to cause inclination or bending.

In addition, in the vehicle body front structure of the embodiment, the enclosure wall 50 protruding forward from the peripheries of the openings of the frame insertion parts 30 and surrounding the outer circumferential surfaces of the front side frames 10 is provided on the load transfer block 11. Then, the crush accommodating space 55 configured to accommodate the crushed portion when the front side frames 10 are crushed in the forward/rearward direction is provided between the enclosure wall 50 and the front side frames 10. For this reason, when the front side frames 10 are crushed and deformed from the front part side toward the rear end side due to the input of the impact load from the front, the crushed portion is accommodated in the crush accommodating space 55 between the enclosure wall 50 and the front side frames 10 according to advance of the crush. Accordingly, the rear regions of the front side frames 10 are supported by the enclosure wall 50 via the accommodated crushed portion, making the rear regions of the front side frames 10 less susceptible to bending and deformation. Accordingly, when the configuration is employed, this allows the front side frames to undergo smoother crush deformation.

Further, when the configuration is employed, a portion of the crushed portion accommodated in the crush accommodating space 55 also wraps around to the front surface side of the load support wall 32. For this reason, retraction displacement of the rear regions of the front side frames 10 can also be regulated by the abutment of the crushed portion with the load support wall 32. Accordingly, when the impact load is input, the front side frames 10 can be more smoothly crushed and deformed.

Further, in the vehicle body front structure of the embodiment, the plurality of bolts 35A configured to fix the front side frames 10 to the lower walls of the frame insertion parts 30 are provided, and the bolts 35A are disposed in a zigzag pattern in the vehicle width direction toward the forward/rearward direction. For this reason, when the impact load is input from the front, if the crushing of the front side frames 10 advances to the rear regions, the peripheral portion of each bolt 35A also undergoes deformation from front to rear. Here, since the plurality of bolts 35A are disposed in a zigzag pattern, deformation points in the rear regions of the front side frames 10 are distributed to two positions in the vehicle width direction, but deformation is more likely to occur alternately between the two positions. Accordingly, when the configuration is employed, it is possible to effectively suppress the collapse or breakage of the front side frames 10 during the later stages of the impact load input.

In addition, in the vehicle body front structure of the embodiment, the left and right sidewalls of the front side frames 10 are connected to the reinforcement wall 37 which extends across the internal space of the front side frames 10. Then, the reinforcement wall 37 extends across at least the fastening part of the bolt 35B (second fastening member) in the forward/rearward direction. For this reason, when the impact load is input from the front, the load transmitted to the left and right sidewalls of the front side frames 10 can be distributed roughly equalized by the reinforcement wall 37. In particular, in the case of the structure in which only one of the left and right sidewalls of the front side frames 10 is fastened and fixed to the frame insertion parts 30 by the bolts 35B as in this embodiment, it is possible to avoid stress concentration only on one of the left and right sidewalls of the front side frames 10.

Accordingly, when the configuration is employed, it is possible to effectively suppress the collapse or breakage in the leftward/rightward direction of the front side frames 10 during the later stage of the impact load input.

In addition, in the vehicle body front structure of the embodiment, the bolts 35A (first fastening members) for fixing to the lower walls of the front side frames 10 and the bolts 35B (second fastening members) for fixing to the sidewalls fasten and fix the front side frames 10 and the frame insertion parts 30 at positions offset to each other in the forward/rearward direction. For this reason, when the crushing of the front side frames 10 advances to the rear region upon input of the impact load from the front, deformation of the periphery of the bolt 35A for fixing to the lower wall and deformation of the periphery of the bolts 35B for fixing to the sidewalls become more likely to occur alternately. Accordingly, when the configuration is employed, it is possible to effectively suppress the collapse or breakage of the front side frames 10 during the later stages of the impact load input.

The present invention is not limited to the above-mentioned embodiment, and various design changes may be made without departing from the spirit of the present invention. For example, in the above-mentioned embodiment, while only one of the left and right sidewalls of the front side frames 10 is fixed to the frame insertion part 30 by the bolt 35B, both the left and right sidewalls of the front side frames 10 may be fixed to the frame insertion parts 30 by the bolts 35B.

In addition, in the above-mentioned embodiment, the bolts 35A configured to fasten the lower walls of the front side frames 10 to the frame insertion parts 30 in the upward/downward direction are disposed in a zigzag pattern. However, the bolts 35B configured to fasten the sidewalls of the front side frames 10 to the frame insertion parts 30 in the vehicle width direction may be disposed similarly in a zigzag pattern. Further, only the bolts 35B configured to fasten the sidewalls of the front side frames 10 to the frame insertion parts 30 in the vehicle width direction may be disposed in a zigzag pattern.

Further, in the above-mentioned embodiment, the load support wall 32 of the load transfer block 11 stands upward from the edge portion of the opening of the frame insertion part 30, and the bracket 33 protrudes upward from the upper surfaces of the front side frames 10. However, the load support wall 32 may be raised to the side or downward from the edge portion of the opening of the frame insertion part 30, and the bracket 33 overlapping the load support wall 32 may be similarly made to protrude to the side or downward. Even in this case, the bracket 33 can be fastened to the load support wall 32 in the forward/rearward direction by the bolt 34.

In addition, in the case of the above-mentioned embodiment, the load transfer block 11 has a block of a left region to which the left front side frame 10 is fixed and a block of a right region to which the right front side frame 10 is fixed, which are formed integrally. However, the load transfer block may be constituted by a block of a left region and a block of a right region, which are separate parts.

### BRIEF DESCRIPTION OF THE REFERENCE SYMBOLS

10 . . . Front side frame
11 . . . Load transfer block
30 . . . Frame insertion part
32 . . . Load support wall
33 . . . Bracket
34 . . . Bolt (third fastening member)
35A . . . Bolt (first fastening member)
35B . . . Bolt (second fastening member)
37 . . . Reinforcement wall
50 . . . Enclosure wall
55 . . . Crush accommodating space

What is claimed is:

1. A vehicle body front structure comprising:
front side frames extending from sides of a front part of a vehicle substantially in a forward/rearward direction; and
a load transfer block that is a casting part configured to connect rear parts of the front side frames to separate frame members,
wherein the load transfer block has:
a frame insertion part that opens forward, and into which the rear region of the front side frames is inserted from the opening; and
a load support wall standing from an edge portion of the opening in a direction substantially perpendicular to the forward/rearward direction,
a bracket protruding in a direction crossing the forward/rearward direction and abutting a front surface of the load support wall is provided at a position in front of an area of the front side frames inserted into the frame insertion part,
the front side frames are fastened and fixed to a circumferential wall of the frame insertion part from the upward/downward direction by a first fastening member and fastened and fixed to the circumferential wall in a vehicle width direction by a second fastening member in a state in which the rear region is inserted into the frame insertion part of the load transfer block, and
the bracket is fastened and fixed to the load support wall of the load transfer block in the forward/rearward direction by a third fastening member.

2. The vehicle body front structure according to claim 1, wherein the load support wall of the load transfer block stands upward from the edge portion of the opening, and
the bracket stands upward from upper surfaces of the front side frames.

3. The vehicle body front structure according to claim 1, wherein the load transfer block further has an enclosure wall protruding forward from a periphery of the opening of the frame insertion part and surrounding outer circumferential surfaces of the front side frames, and
a crush accommodating space configured to accommodate a crushed portion when the front side frames are crushed in the forward/rearward direction is provided between the enclosure wall and the front side frames.

4. The vehicle body front structure according to claim 1, wherein at least one of the first fastening member and the second fastening member is provided in plural, directed in the forward/rearward direction and disposed in a zigzag pattern in a direction crossing the forward/rearward direction.

5. The vehicle body front structure according to claim 1, wherein a reinforcement wall extending across an internal space of the front side frames is connected to left and right sidewalls of the front side frames, and
the reinforcement wall extends across at least a fastening part of the second fastening member in the forward/rearward direction.

6. The vehicle body front structure according to claim 1, wherein the first fastening member and the second fastening member fasten and fix the front side frames and the frame insertion part at positions offset to each other in the forward/rearward direction.
